(19) United States
(12) Patent Application Publication
(10) Pub. No.: US 2022/0145532 A1
(43) Pub. Date: May 12, 2022

(54) FABRIC TREATMENT COMPOSITIONS

(71) Applicant: HEWLETT-PACKARD DEVELOPMENT COMPANY, L.P., Spring, TX (US)

(72) Inventors: Xiaoqi ZHOU, San Diego, CA (US); Or BRANDSTEIN, San Diego, CA (US)

(73) Assignee: HEWLETT-PACKARD DEVELOPMENT COMPANY, L.P., Spring, TX (US)

(21) Appl. No.: 17/598,715

(22) PCT Filed: Feb. 7, 2020
(86) PCT No.: PCT/US2020/017229

§ 371 Date: Sep. 27, 2021

(51) Int. Cl. D06P 5/30; C09D 11/54; C09D 11/322; D06P 5/00; D06P 5/22; B41J 3/407; D06P 1/54

(52) U.S. Cl. CPC D06P 5/30; C09D 11/54; C09D 11/322; D06P 1/54; D06P 5/22; B41J 3/4078; D06P 5/002

(57) ABSTRACT

A fabric treatment composition for preparing a fabric substrate for printing is described. The fabric treatment composition comprises at least one fibre-bonding agent, at least one hydrophobicity agent and at least 50 weight % water. A method is also described comprising applying, to at least an area of a fabric substrate, a fabric treatment composition to form a coating, wherein the fabric treatment composition comprises at least one fibre-bonding agent, at least one hydrophobicity agent and a carrier liquid; and printing at least one ink composition onto the coating. A printable fabric medium is also described comprising a fabric substrate; and a coating formed on at least one side of at least an area of the substrate.

### BACKGROUND

Textiles and fabrics are flexible materials formed of a woven or non-woven network of natural or artificial fibres. Fabrics have an assortment of uses in daily life, such as clothing, bags, baskets, upholstered furnishings, window shades, towels, coverings for tables, beds, and other flat surfaces, as well as in art. Fabrics are used in many traditional crafts such as sewing, quilting and embroidery.

Images may be printed onto fabrics by a range of printing methods, including inkjet printing.

### BRIEF DESCRIPTION OF THE DRAWINGS

Features of examples of the present disclosure will become apparent by reference to the following detailed description, examples and drawings.

FIG. 1 is a schematic illustration of an example spray application process;

FIG. 2A is a schematic view of a first example nozzle spray pattern and nozzle;

FIG. 2B is a schematic view of a second example nozzle spray pattern and nozzle;

FIG. 2C is a schematic view of a first example nozzle spray pattern and nozzle;

FIG. 3 is a schematic illustration of an example of a first roller coating process;

FIG. 4 is a schematic illustration of an example of a second roller coating process;

FIG. 5 is a schematic illustration of an example of a third roller coating process;

FIG. 6 is a schematic illustration of an example of a fourth roller coating process; and

FIG. 7 is a schematic illustration of an example of a fifth roller coating process.

The figures depict several examples of the present disclosure. However, it should be understood that the present disclosure is not limited to the examples depicted in the figures.

### DETAILED DESCRIPTION

The present disclosure provides a fabric treatment composition for preparing a fabric substrate for printing, wherein the fabric treatment composition comprises at least one fibre-bonding agent, at least one hydrophobicity agent and at least 50 weight % water.

Images can be printed onto fabric substrates by printing, e.g. inkjet printing. However, challenges for printing on fabric substrates can arise from, for example, image quality and image durability in response to daily use and exposure to laundry detergents. Some printing media, such as cotton or cotton blends-based fabrics such as T-shirt fabrics, may have relatively strong hydrophilic characteristics. This hydrophilicity may allow aqueous inkjet inks to penetrate easily into the bulk of the fabric substrate. Excessive ink penetration can reduce optical density and colour vividness in CMYK ink printing, but may also damage white film-formation and decrease opacity or L* in white ink printing.

A further challenge may be fibrillation, or so-called fibre “stick-out”, in which fibres or the ends of fibres extend or protrude outwardly from the surface of the fabric (in other words, in its z-direction). This may occur in some fibrous substrates such as some cotton-based substrates and mixed-fibre substrates. Protruding fibres can reduce smooth film-formation and can leave debris on the top surface.

In some cases, the effect of fibrillation or fibre “stick-out” may be detected by visual inspection, for instance, when printing a white image using white inks onto black or dark fabric substrates (for example, substrates having a CIELAB Color Space L* value of 0 to about 40). Similar effects may be observed when printing colour inks on black or dark substrates where a white primary ink layer is required; or where the L* value of the ink is about 50 points or more greater than the L* value of the fabric.

The fabric treatment compositions of examples of the present disclosure may improve image quality and/or image durability of images applied to the substrate by inkjet printing. In some examples, the fabric treatment composition may reduce fibrillation and/or excessive ink penetration into the substrate.

In some examples, the at least one fibre-bonding agent may be present in an amount of from about 0.05 wt % to about 2 wt %; the at least one hydrophobicity agent may be present in an amount of from about 0.1 wt % to about 10 wt %; and water may be present in an amount of from about 85 wt % to about 99.5 wt %.

In some examples, water may be present in an amount of at least about 75 weight %, at least about 80 weight %, at least about 85 weight %. Water may be present in an amount of at most about 99.5 weight %, at most about 99 weight %, at most about 97 weight %, at most about weight 95%. In some examples, water may be present in an amount of about 75 to about 99 weight %, about 80 to about 97 weight % or about 85 to about 95 weight %.

In certain examples, the ratio of the at least one hydrophobicity agent to the at least one fibre bonding agent may be in the range of 1 to 20 parts by weight of hydrophobicity agent to one part of fibre-bonding agent. In certain examples, the ratio of the at least one hydrophobicity agent to the at least one fibre-bonding agent may be in the range of 1 to 10 parts by weight, for instance, 2 to 5 parts by weight of hydrophobicity agent to one part of fibre-bonding agent. In one example, the ratio of the at least one hydrophobicity agent to the at least one fibre bonding agent is about 3 parts of hydrophobicity agent to one part fibre-bonding agent.

In some examples, the fibre-bonding agent may have a glass transition temperature (Tg) of less than 5° C. In other examples, the fibre-bonding agent may have a glass transition temperature (Tg) of from −30° C. to 0° C. or a glass transition temperature (Tg) of from −20° C. to −5° C.

A polymer with a higher Tg can tend to make the fabric feel stiffer, as perceived by some consumers. It may also give a higher degree of shininess to the fabric which may be undesirable to some consumers. Elasticity may also be affected by using a fibre-bonding agent having a Tg higher than 5° C.

In some examples, the fibre-bonding agent may be an agent selected from water dispersible polymers and copolymers; and latex-containing particles, polymers and copolymers.

In certain examples, the fibre-bonding agent may be at least one agent selected from water dispersible polymers or latex-containing particles. The fibre-bonding agent may be selected from acrylic polymers, polyvinyl acetate, polyesters, polymers of vinylidene chloride, styrene-butadiene copolymer, acrylonitrile-butadiene copolymer; and polyurethane.

In a further example, the fibre-bonding agent may include an acrylonitrile-butadiene latex.

In other examples, the at least one fibre-bonding agent may be at least one fibre-bonding agent selected from the group consisting of acrylic polymers and copolymers, vinyl-acrylic copolymers and acrylic-polyurethane copolymers, which includes various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, for example.

In certain examples, the fibre-bonding agent may be an acrylic polymer or a urethane polymer or a mixture or copolymer thereof.

In some examples, wherein the fibre-bonding agent has an average molecular weight (Mw) of about 500 to about 200,000, about 10,000 Mw to about 200,000 Mw, about 20,000 Mw to 100,000 Mw, or about 100,000 Mw to 200,000 Mw.

In the some examples of present disclosure, at least one hydrophobicity agent may be used in the composition. The at least one hydrophobicity agent may form film or non-continuous domains at the surface of the yarn from which the fabric may be made or on the surface of the fabric to form a special surface having the desirable surface energy as described below.

As used herein, the term ‘hydrophobicity agent’ or ‘hydrophobic agent’ is used to describe a component of the composition which imparts hydrophobic properties to the substrate, or which increases the capability of the surface to repel water or other aqueous solution in the ink vehicles.

In some examples, the at least one hydrophobicity agent may be selected from silicone-based compounds. In certain examples, the silicone-based compounds may be selected from siloxanes, silanols and silanes.

In other examples, the at least one hydrophobicity agent may be at least one agent selected from organic fluorocarbon compounds; fluorocarbon compounds having a hydrocarbon polymer backbone and appended fluorinated C1 to C8 alkyl chains or rings or fluoroalkyl chains or rings, or derivatives thereof.

In some examples, the short chains or rings may be C4 or C6. Examples include poly(fluorooxetane), acrylate-modified poly(fluorooxetane), perfluorooctane sulfonate (PFOS) and perfluorooctanoic acid (PFOA).

The composition comprises at least 50% water as a liquid carrier. Water provides a fabric-compatible medium for the application of the hydrophobicity agent and fabric bonding agent of the present disclosure to fabrics, particularly fabrics of the types commonly used for clothing. Organic solvents may be incompatible with some fabrics, such as fabrics formed wholly or partially from synthetic fibres.

In some examples, the liquid carrier may be water and a co-solvent. In certain examples, the co-solvent may be ethanol, butanol, or low molecular weight (less than about 100) polyethylene glycol or polyethylene oxide.

In some examples, the at least one hydrophobicity agent may be chosen to control the critical surface energy or surface tension (γ) of a fabric substrate treated with the composition to a surface energy from about 25 millinewton per meter (mN/m) to about 45 mN/m at 25° C., from about 30 mN/m to about 45 mN/m at 25° C., or from about 40 mN/m to about 45 mN/m.

The fabric treatment compositions of the present disclosure may also include other processing aids such as one or more surfactants and/or pH adjustors or buffers.

In certain examples, the composition may further comprise at least one cross-linking agent.

In some examples, the at least one cross-linking agent may be at least one cross-linking agent having functional groups able to form a cross-linking reaction with reactive groups such as amine, carboxyl, hydroxyl and thiol. Such groups may be present on the fabric substrate, and/or may be present in the fabric treatment composition and/or ink that may be applied to the fabric substrate. In some examples, the cross-linking agent may crosslink with e.g. the binders of any ink applied to the coating. In some examples, the crosslinking agent may cause a crosslinking reaction that can improve adhesion of the coating e.g. to the fabric and/or ink applied over the coating.

The cross-linking agent may be a heterocyclic ammonium salt. In one example, the heterocyclic salt may be a quaternary ammonium salt of a four membered heterocyclic ring. In one example, the salt may be an azetidinium salt. For instance, the crosslinking agent may be a heterocyclic ammonium salt e.g. obtained from the reaction of a primary amine or a secondary amine with epichlorohydrin.

In certain examples, the composition may further comprise at least one ink-crashing agent.

In some examples, the at least one ink crashing agent may be at least one agent selected from water soluble metallic organic salts, water-soluble metallic inorganic salts; and ionene compounds.

The present disclosure also describes printing media obtained by treating a fabric and methods of using the compositions to make the printing media.

The present disclosure also includes a method of printing a fabric substrate, said method comprising: i) applying, to at least an area of a fabric substrate, a fabric treatment composition to form a coating, wherein the fabric treatment composition comprises at least one fibre-bonding agent, at least one hydrophobicity agent and at least 50% water; and ii) printing at least one ink composition over the coating.

The terms “coating” or “coating layer” do not necessarily imply a contiguous layer but includes a partial and/or discontinuous coating over the fabric.

The fabric treatment composition may be applied by any method, including, for example, by spraying, dipping, spreading, soaking and/or printing (e.g. digital (inkjet) printing or screen printing).

The at least one ink composition may be an inkjet ink composition. The at least one ink composition may be printed by inkjet printing.

In some examples, the at least one ink composition comprises a white pigment, a polymer binder and a carrier liquid.

At least the area of the fabric substrate that is treated with the fabric treatment composition may be of a dark colour or tone, for example, black. In some examples, the fabric substrate may be of a dark colour, for example, black. At least the area of the fabric substrate that is treated with the fabric treatment composition may have a CIELAB Color Space L* value of 0 to about 40, for example, 0 to 30 or 0 to 20 or 0 to 10. In some examples, the fabric substrate may have a CIELAB Color Space L* value of 0 to about 40, for example, 0 to 30 or 0 to 20 or 0 to 10. In some examples, the L* value of the ink may be about 50 points or more, about 60 points or more, about 70 points or more or about 80 points or more greater than the L* value of the fabric.

In some examples, the ink may be a white ink. In certain examples, the ink may be a white ink comprising TiO₂ as a pigment. The pigment may be present in an amount of 0.1 to 20 weight %, for example, 0.5 to 15 weight %, for example, 1 to 10 weight %.

The ink may comprise a polymer binder. The polymer binder may be present in an amount of 1 to 20 weight %, for example, 1 to 15 weight %, for instance 2 to 12 weight % or 3 to 10 weight %. In some examples, the polymer binder may be present in an amount of 5 to 8 weight % (e.g. about 6 weight %). The polymer binder may be comprise a polyurethane and/or an acrylic polymer (e.g. polyacrylic latex polymer). Examples of suitable polyurethanes include polyurethane dispersions and polyurethane-latex hybrid polymers. In one example, the polymer binder may be a polyester-polyurethane dispersion, for example, an aliphatic polyester-polyurethane dispersion. The polymer binder may be charged. In one example, the polymer binder may be an anionic aliphatic polyester-polyurethane dispersion. A suitable binder may be available from Covestro® AG under the trademark Impranil® DLN-SD.

The ink may include a humectant. An example of a humectant may be glycerol. The humectant (e.g. glycerol) may be present in an amount of 1 to 20 weight %, for example, 1 to 15 weight %, for instance 2 to 12 weight % or 3 to 10 weight %. In some examples, the polymer binder may be present in an amount of 5 to 8 weight % (e.g. 6 weight %).

The ink may include an anti-kogation agent. The anti-kogation agent may be present in an amount of 0.01 to 5 weight %, for example, 0.1 to 1 weight % (e.g. 0.5 weight %). An anti-kogation agent may help to reduce the risk of residue build-up at or in the inkjet printhead. An example of a suitable anti-kogation agent may be a phosphate ester. A suitable phosphate ester is oleth-3 phosphate. An example of a suitable anti-kogation agent may be supplied by Croda® under the trademark Crodafos® N-3A.

The ink may include a surfactant. In some examples, the ink may include two or more surfactants. Non-ionic surfactants may be employed. Suitable surfactants include ethoxylates and self-emulsifiable wetting agent based on acetylenic diol chemistry. In some examples, the amount of surfactant ranges from 0.01 to 10 weight %, for example, 0.1 to 5 weight %.

In one example, an ink may comprise a pigment, a polymer binder, a humectant, an anti-kogation agent, a surfactant, water. The ink may also include a biocide. In one example, the ink may be a white ink comprising titanium dioxide, a polymer binder, a humectant, an anti-kogation agent, a surfactant, a carrier liquid (e.g. water) and, in some examples, a biocide. The binder may be a polyester-polyurethane dispersion as described above.

An example of a white ink is one that may be formulated based on the following recipe: 6% of an anionic aliphatic polyester-polyurethane dispersion (e.g. as available under the trademark Impranil® DLN-SD, 6% of glycerol, 0.5% of oleth-3-phosphate (e.g. as available under the trademark, Crodafos® N-3A Acid), 1% of 26 mole ethoxylate of glycerin (e.g. available under the trademark LIPONIC® EG-1), 0.22% of biocide (e.g. Aticide® B20), 0.3% of surfactant (e.g. Surfynol 440), 10% TiO₂ pigment dispersion and the balance being water. Prints may be printed on a HP Innovator durability plot in an amount of 24-42 dpp (dots per pixel) using a HP A3410 pen on Gildan 780 black T-shirt fabric.

The ink (e.g. white ink) can be digitally-jetted using a inkjet pen in a single pass or in multiple passes to achieve higher opacity.

In certain examples, a cross-linking composition may be applied before or after application of the ink layer. For example, the crosslinking composition may be applied to the ink layer formed by printing the ink composition over the coating. Alternatively, the crosslinking composition may be applied prior to printing the ink composition over the coating. In some examples, a cross-linking composition may be applied between each pass of ink layers (e.g. white ink layers). In some examples, the crosslinking ink composition may be digitally-jetted using a inkjet pen, nozzle or printhead. In certain examples, the process comprises multiple passes of ink (e.g. white ink) application with an application of a cross-linking composition.

The crosslinking composition may comprise at least one cross-linking agent. Suitable crosslinking agents are as described herein. The cross-linking agent may be a resin that is reactive with amine, carbonyl, hydroxyl or thiol groups in the underlying fabric treatment layer or (white) ink layer. The cross-linking agent may cause a cross-linking reaction that can improve adhesion of any underlying or overlying ink layer. Crosslinking may also improve hydrophobicity and/or durability of the layer(s).

The cross-linking agent may be a heterocyclic ammonium salt. In one example, the heterocyclic salt may be a quaternary ammonium salt of a four membered heterocyclic ring. In one example, the salt may be an azetidinium salt. For instance, the crosslinking agent may be a heterocyclic ammonium salt e.g. obtained from the reaction of a primary amine or a secondary amine with epichlorohydrin.

The cross-linking composition may be applied (e.g. by inkjet printing) between consecutive ink (e.g. white ink) applications. In one example, the cross-linking composition comprises a cross-linking agent, surfactant and solvent. Yet, in another example, the cross-linking composition may be filled into a thermal inkjet (TIJ) pen and jetted before each pass of white ink jetted in an amount of 6-9 dpp. Further, in another example, the cross-linking composition may be jetted using a HP A3410 pen.

In one example, the crosslinking composition may comprise about 0.1 to 20 weight %, for example, 0.5 to 10 weight % or 1 to 8 weight % of a crosslinking agent. The crosslinking agent may also include a humectant. For example, the crosslinking agent may include about 0.1 to 20 weight %, for example, 0.5 to 10 weight % or 1 to 8 weight % of a humectant. The crosslinking agent may also include an anti-kogation agent, for example, 0.01 to 5 weight %, for example, 0.1 to 1 weight % of an anti-kogation agent.

In one example, the crosslinking agent includes about 4% 2,2 dimethyl 1,3 propanediol, 0.5% of oleth-3-phosphate (available under the trademark, Crodafos® N-3 Acid) and 4% of a reaction product between a polyamide/polyamine and an epichlorohydrin as crosslinking agent (available under the trademark Polycub® 7350), with the balance being water.

In some examples, the method further comprises a step of printing one or more CMYK inks onto a white ink layer. In one example, the CMYK ink may be formulated based on the following recipe: 6% of an anionic aliphatic polyester-polyurethane dispersion (e.g. as available under the trademark Impranil® DLN-SD, 6% of glycerol, 0.5% of oleth-3-phosphate (e.g. as available under the trademark, Crodafos® N-3A Acid), 1% of 26 mole ethoxylate of glycerin (e.g. available under the trademark LIPONIC® EG-1), 0.22% of biocide (e.g. Aticide® B20), 0.3% of surfactant (e.g. Surfynol 440), 2 to 4 weight % pigment dispersion and the balance being water. The prints were printed using a HP Innovator with durability plot in an amount of 3 dpp ink for CMYK

The present disclosure further includes a printable fabric medium comprising: i) a fabric substrate; and ii) a coating formed on at least one side of at least an area of the substrate, wherein the coating wherein the coating comprises a fabric treatment composition comprising at least one fibre-bonding agent and at least one hydrophobicity agent. The coating may be formed from a fabric treatment composition comprising at least one fibre-bonding agent, at least one hydrophobicity agent and a carrier liquid as described in the present disclosure.

In some examples, the coating layer may have a dry coat weight of 0.05 gsm to 5 gsm (grams per square meter of the fabric substrate which is treated) or 0.5 gsm to 2 gsm.

In some examples, the present disclosure may also include a kit comprising a fabric treatment composition as defined above, an ink composition and a cross-linking composition.

In one example, the ink composition may be a white ink composition. Both ink composition and cross-linking composition can be stored either inside a printing head of a printer or in a separate container fluidically connected with the printing head, and digitally applied on the pre-treated fabric with a fabric treatment composition described in the present disclosure.

In some examples, the kit may further comprise at least one of a set of CMYK inks.

In certain examples, the fluid set may comprise a fabric treatment composition as described above, a white ink, a cyan ink, a magenta ink and a yellow ink. In some examples, the fluid set further comprises a black ink.

In some examples, the method may include the step of drying the coating layer prior to printing the at least one ink composition to the dried coating layer.

In certain examples, the method may further comprise subjecting the printed substrate to a post-printing process to effect cross-linking between the fabric substrate, any cross-linking agent in the fabric treatment composition of the present disclosure and binder in the ink composition. The post-printing process may include applying heat or heat and pressure to the printed substrate at a temperature sufficient to cause cross-linking, for example, at temperatures of above 60° C. Examples of suitable temperatures include temperatures of, for example, at least 70° C. or at least 80° C. Suitable upper limits include temperatures of up to 220° C., for example, up to 200° C., up to 180° C. or up to 160° C. In some examples, curing temperatures of 60 to 220° C., for example, 70 to 200° C. or 80 to 180° C. or 80 to 160° C. may be employed.

In some examples, the present disclosure also discloses the use of a composition as defined above as a fabric pre-treatment in a fabric printing process.

In some examples, the present disclosure also discloses a printable fabric medium comprising: i) a fabric substrate; and ii) a coating formed on at least an area of the substrate, wherein the coating may be formed by applying a composition as described above.

In certain examples, the composition may be applied to the pre-treated fabric or textile substrate to form a dry coat weight of 0.05 gsm to 5 gsm or 0.5 gsm to 2 gsm for each coated area of the substrate.

The present disclosure discloses fabric treatment compositions, methods of using the fabric treatment compositions and fabrics treated with the compositions for a wide range of textile printing substrates which may achieve excellent printing image quality at fast speed and may have excellent image durability.

### Hydrophobicity Agent

Fabric substrates for printing purposes exhibit a range of surface hydrophobicity depending upon the chemical structure of its threads and of any chemical additives used in a finishing process for the fabric. Cotton or cotton blend-based fabrics, for example, may have strong hydrophilic characteristics due to —OH groups on the cellulose molecular structure. Some grades of fabric substrate may alter the hydrophobicity after softening processing, depending upon the chemical composition and dosage of the materials used in the process. Since hydrophilicity allows aqueous inkjet inks to easily penetrate the bulk of the fabric substrate, it may reduce ink optical density and, more significantly in the case of white ink printing on black or coloured fabrics, decrease the formation of an ink film. The opacity or L* of white ink applied may be decreased. A printing substrate having an optimum level of hydrophobicity may reduce penetration of the solvent of aqueous inkjet inks.

In this disclosure the fabric treatment or coating composition comprises a hydrophobicity agent or mixture of hydrophobicity agents. The hydrophobicity agent may be a chemical which can alter the surface energy or surface tension after applied on the fabric surface, to a degree sufficient to repel the aqueous solvent of the inkjet ink and stop or reduce aqueous solution penetration along the z-direction, into the bulk of fabric substrate. Advantageously, the hydrophobicity agent may not diminish the ability of binders in the ink composition to adhere to or on the fabric surface. Modification of the hydrophobicity can be measured by various measurement methods known in the art, such as the contact angle method, and correlated with surface energy or surface tension.

In one example, the hydrophobicity agent can be selected from organic fluorocarbon compounds. For example, the hydrophobicity agent may be selected from fluorocarbon compounds having a hydrocarbon polymer backbone, such as a polyamide, polyester or polyurethane backbone and appended fluorinated short (C1 to C8) alkyl chains or rings or fluoroalkyl chains or rings, and derivatives thereof. In some examples, the short chains or rings may be C4 to C6. In certain examples, the short chains or rings may be C4 or C6. Examples include poly(fluorooxetane), acrylate-modified poly(fluorooxetane), perfluorooctane sulfonate (PFOS) and perfluorooctanoic acid (PFOA).

In some examples, the hydrophobicity agent is an organic fluorocarbon supplied by Huntsman® International LLC, under the trademark, PHOBOL® CP-C.

In another example, the hydrophobicity agent or agents can be selected from silicone-based compounds.

In some examples, the silicone-based compounds may be polymeric polydialkylsiloxanes such as a polydimethylsiloxane. They may be used as aqueous emulsions through dispersing silicone oil in water using an appropriate emulsifier. The silicone structure provides the ability to form hydrogen bonds with fibres and provide hydrophobicity effects to the outer surface of fibres. Silicone compounds can consist of a silanol or a silane. The silanol and silane components react to form a three-dimensional cross-linked sheath around fibres, with the outwardly positioned methyl groups of the silicone polymer generating the hydrophobicity effects.

In other examples, the polydialkylsiloxanes can be selected from polymethylhydrosiloxane, hydromethyl polysiloxane, dimethyl polysiloxane, hydromethyl-dimethyl polysiloxane, polyhexamethyl disiloxane, polyecamethyl tetrasiloxane, polydodecamethyl pentasiloxane, polyoctamethyl trisiloxane, polyoctamethyl cyclotetrasiloxane, polydodecamethyl cyclohexasiloxane, polydecamethyl cyclopentasiloxane, and combinations thereof.

Further, in other examples, the polydialkylsiloxanes used can be a polysiloxane copolymer of Formula 1:

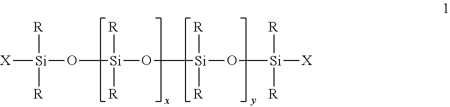

in which x may be an integer from 1 to 500 and y may be an integer from 1 to 20; each R may be an alkyl group such as methyl, and each X may be methyl or an end cap group, such as hydroxyl- or C1-C4 alkoxy-substituted methyl and each X may be the same or different.

R₁ represents an organic group. In some examples, R₁ may be mono amino —R′NH₂, diamino —R′NHRNH₂, an epoxy group

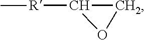

or alicyclic epoxy group.

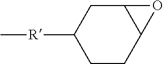

in which each R′ may be hydrogen, an alkyl group (optionally substituted) or may be absent and may be the same or different. In other examples, R₁ may be hydrogen; hydroxyl, forming a silanol group; —R′OH, forming a carbinol group; —R′SH, forming a mercapto group; a carboxyl group, —R′COOH; a phenol group

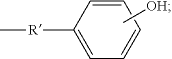

an acrylic group

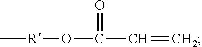

a carboxylic acid; a carboxylic anhydride group

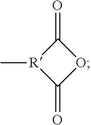

a fluoroalkyl group —CH₂CH₂CF₃; a long chain alkyl group —CₘH₂ₘ₊₁ in which m may be from 2 to 50; a fatty acid ester group —OCOR′; or a fatty acid amide group —RNHCOR′. These reactive groups can either help controlling hydrophobic surface, improve compatibility with aqueous solvent, or reactive with other functional groups, such as —OH, present on the fabric surface, to improve adhesion of the hydrophobic agent with the fabric substrate.

In other examples, the silicone polymer may be selected from organosilicone terpolymers containing a number of reactive epoxy groups and polyoxyalkylene groups, silylated organic polymers obtained by reacting polymeric organic acids with silylated amino functional polyethers, hydrophilic organosilicone, including a trialkoxysilyl pendant group, and a polyoxyethylene/polyoxypropylene chain terminated with a hydrogen or acyl group.

In other examples, the siloxane polymer has a different backbone structure and may be selected from, but not limited to, methyl hydrogen siloxane, hexamethyldisiloxane, octamethyltrisiloxane, decamethyltetrasiloxane, dimethyltetramethoxydisiloxane, and trimethyltrimethoxydisiloxane.

In some examples, the poly alkylsiloxane may be a non-reactive silicone fluid dispersed emulsion in which R₁ may be a polyether of formula —R′(C₂H₄O)ₐ(C₃H₆O)_{b}R′, in which a and b may be each in the range of 5 to 30 and may be the same or different, or R₁ may be an aralkyl

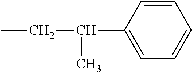

group, optionally substituted.

In some examples, the at least one hydrophobicity agent may be chosen to control the critical surface energy or surface tension (γ) of the base fabric substrate to a surface energy in the range of from about 25 millinewton per meter (mN/m) to about 45 mN/m at 25° C. In another example, the treated base fabric substrate may have a surface energy from about 30 mN/m to about 45 mN/m at 25° C. In other examples, the treated base fabric substrate may be controlled to have a surface energy from about 40 mN/m to about 45 mN/m at 25° C.

The interaction of the hydrophobicity agent with the base fabric substrate can vary depending on the substrate and the hydrophobicity agent. For example, hydrophobicity agents like polysiloxane emulsions can be incorporated into the fibres, lie on the surface of the fibres, or fill the pores and/or spaces between fibres that compose the base fabric substrate. Hydrophobicity agents that are fatty acids can form chemical bonds with the fibres in the base fabric substrate. Hydrophobicity agents such as fluorocarbon polymers can form a physical coating to the surface of the fibres that compose the base fabric substrate.

The hydrophobicity agent can control the surface energy (γ) of the base fabric substrate. In one example, the treated base fabric substrate can have a surface energy from about 25 millinewton per meter (mN/m) to about 45 mN/m at 25° C. In another example, the treated base fabric substrate may have a surface energy from about 30 mN/m to about 45 mN/m at 25° C. In other examples, the treated base fabric substrate may have a surface energy from about 40 mN/m to about 45 mN/m. The surface energy (γ) can be measured by conventional means, such as with a force tensiometer (such as the K11 tensiometer by Krüss, North Carolina).

The hydrophobicity agent may be present in the fabric treatment composition in an amount of 0.1 weight % to about 10 weight %, for example, about 0.2 weight % to about 5 weight % or about 0.5 wt % to about 2 wt %, based on the dry weight of hydrophobicity agent.

The weight ratio of the hydrophobicity agent to the fibre-bonding agent may be of 1-10:1, for example, 2-5:1 or 3-4:1.

### Fibre-Bonding Agent

The fibrous structure on some fabric substrates brings another challenge to the digital printing. Loose fibres can sometimes not be woven or plaited into the fabric surface and may protrude or “stick-out” of the surface (in the z-direction), and often have a dense appearance. When digital inks are printed onto the fabric substrate, the sticking-out fibres can impact the layout of the applied ink drops and impact the coherence of the ink film. These influences can reduce ink uniformity and ink density and give rise to poor image quality and image durability due to poor ink adhesion to substrate surface.

In known techniques, sticking-out fibres can be removed during the manufacture of fabrics and textiles, by processing steps such as singeing or enzymatic treatment, but these additional processing steps can increase manufacturing cost and complexity. Therefore, in some applications (e.g. in middle to low-grade fabric substrates, such as may be used for relatively low value fabric products such as promotional T-shirt fabric substrates) the fabric may be shipped ‘as-is’ without any treatment to remove stick-out fibres.

In the present disclosure, a fibre-bonding agent may be added in the fabric treatment composition. Without wishing to be bound by any theory, it may be understood that the bonding agent may firstly soften the fibres and may then hold the stick-out or loose fibres against the surface of the fabric. The process may be aided by the pressure applied in surface coating or pre-treatment processes in which the fabric substrate passes between two rollers, such as between a printing or application roller and an impression or nip roller during padding processing. A fibre-bonding agent may also enhance the substrate smoothness microscopically which may help to improve further the image quality, often dramatically, especially in those cases in which the hydrophobicity agent may be a substance having a molecular weight of from about 200 to about 500.

The at least one fibre-bonding agent may be any suitable composition. During a pre-treatment or coating process, the fibre-bonding agent may be capable of softening fibres under wet conditions and holding the fibres down in a dry condition, without any substantially changing the physical properties of the fabric of interest to a consumer, such as touch or softness.

The composition can be applied during fabric manufacture processing, for example, during wet surface finishing, and then dried in the dye house of the manufacturing site. In this case, the treated fabric may be printed based on dry-on-wet printing. Alternatively, the composition can be applied to a fabric by means of a treatment or coating device integrated into a printer. In such a case, there may be no drying mechanism incorporated to dry the fabric between treatment and printing (ie., wet-on-wet printing). A fibre-bonding agent intended for such a process may alternatively or additionally both soften fibres under wet conditions and hold the fibres of the fabric down at least temporarily in the wet condition prior to printing, without any negative impact to the physical properties of the fabric, such as touch or softness when the fabric is dried.

The fibre-bonding agent can be either water soluble synthetic or natural substance or an aqueous dispersible synthetic or natural polymeric substance. In some other examples, the fibre-bonding agent may be a polymeric latex.

In some examples, the fibre-bonding agent has a glass transition temperature (Tg) that may be 5° C. or less. A fibre-bonding agent having a higher glass transition temperature (Tg) may contribute to an increasingly stiff coating which may, in some circumstances, impair the fabric “hand feel” of the printing media. In some examples, the fibre-bonding agent has a glass transition temperature (Tg) ranging from −30° C. to 0° C. In some other examples, the fibre-bonding agent has a glass transition temperature (Tg) ranging from −20° C. to −5° C. Measurement of glass transition temperature (Tg) is described in, for example, Polymer Handbook, 3rd Edition, authored by J. Brandrup, edited by E. H. Immergut, Wiley-Interscience, 1989.

In some examples, the fibre-bonding agent may be an agent selected from water soluble polymers and copolymers, water dispersible polymers and copolymers; latex-containing particles, polymers and copolymers.

In certain examples, the at least one fibre-bonding agent may be selected from polymers and copolymers which meet the Tg condition as above.

In some examples, the fibre-bonding agent may be selected from one or more polymers like polyacrylates and copolymers thereof, polyvinyl acetates, polyesters, polyvinylidene chlorides, styrene-butadiene or acrylonitrile-butadiene copolymers, polyacrylic acids, polyacrylic esters, polymethacrylic esters and polyurethanes.

In a further example, the fibre-bonding agent may include an acrylonitrile-butadiene copolymer.

In yet a further example, the fibre-bonding agent may include an acrylic polymer, for example, a polyacrylic acid, polyacrylate, polymethacrylic acid or polymethacrylate.

In other examples, the at least one fibre-bonding agent comprises at least one fibre-bonding agent selected from latex-containing particles of a vinyl acetate-based copolymer, an acrylic polymer and copolymer, a styrene copolymer, an SBR-based copolymer, a polyester-based copolymer, a vinyl chloride-based copolymer, or the like.

In other examples, the at least one fibre-bonding agent may be at least one fibre-bonding agent selected from the group consisting of acrylic polymers and copolymers, vinyl-acrylic copolymers and acrylic-polyurethane copolymers, and includes polymers formed by copolymerising monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, for example.

In certain examples, the polymeric fibre-bonding agent may have an average molecular weight (Mw) of about 500 to about 200,000. In another example, the average molecular weight of the polymeric binder may be from 10,000 Mw to about 200,000 Mw. In yet another example, the average molecular weight of the polymeric binder may be from 20,000 Mw to 100,000 Mw. In a further example, the average molecular weight of the polymeric binder may be from 100,000 Mw to 200,000 Mw. In one example, the polymeric binder may have a weight average molecular weight from 5,000 Mw to 200,000 Mw.

In some examples, the fibre bonding agent may be a cationic, anionic or non-ionic polymer. Suitable polymers include the polymers mentioned above. In some examples, the fibre bonding agent may be a cationic or non-ionic polymer. For example, where the crosslinking agent is cationic, the fibre-bonding agent may be cationic or non-ionic.

In some examples, the fibre-bonding agent may be a cationic acrylic emulsion polymer. In certain examples, the fibre-bonding agent may be a cationic acrylic emulsion polymer from the Raycat® range of polymers, from Specialty Polymers, Inc. In one example, the fibre-bonding agent is Raycat® 100.

In some examples, the fibre-bonding agent may be a styrene-butadiene emulsion.

In some examples, the polymeric fibre-bonding agent may be a self-crosslinkable aqueous acrylic dispersion. An example may be Edolan® AB available from Tanatex Chemicals (having a solids content of 45% and Tg of −18° C.).

The polymeric fibre-bonding agent may be selected in all the examples of this disclosure to have chemical compatibility with the hydrophobic agents and any reactive cross-linking agent (described in detail below) such that, when the components of the composition are mixed together, no precipitation or gelling takes place.

In some examples, the fibre-bonding agent may be present in an amount of from about 0.01 to about 10 weight %, for example, 0.02 to about 5 wt % or 0.05 wt % to about 2 wt %. In some examples, the fibre-bonding agent may be present in an amount of from 0.1 wt % to about 1.5 wt % or from 0.6 to about 1.2 wt %.

### Cross-Linking Agent

In some examples, the fabric treatment composition further comprises at least one cross-linking agent.

In some examples, the at least one cross-linking agent may be present in an amount of from about 0.01 to about 5 weight %, for example, about 0.05 to about 2 wt % or 0.1 to about 1.0 weight %.

Where a cross-linking agent is employed in the fabric treatment composition, the weight ratio of the fibre-bonding agent to the cross-linking agent may be from 0.5-10:1, for example, 1-5:1 or 1.5-4:1, for instance, 2-3:1.

The cross-linking agent may be a compound having functional groups able to form a cross-linking reaction with reactive groups such as amine, carboxyl, hydroxyl and thiol of the fabric substrate, fibre-bonding agent of the fabric treatment composition and/or binders of pigmented inks, for example, under conditions of heating at 50° C. to 200° C., or by any other process whereby chains of a polymer become attached to each other or to the fabric substrate, including by thermal methods or by treatment of light of appropriate wavelength, for example. The cross-linking agent may be compatible with the solvent, typically an aqueous solvent such as water, the hydrophobicity agent and the fibre-bonding agent to form a uniform solution without phase separation or gelling.

In one example, the cross-linking agent may be a heterocyclic ammonium salt. Further, in one example, the heterocyclic salt may be a quaternary ammonium salt of a four membered heterocyclic ring of Formula 2:

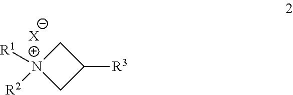

wherein R³ may be hydroxyl, carboxy, acetoxy, alkoxy, amino or alkyl, for example at the 3′-position, and R¹ and R² may be end groups connecting the 1,1′-nitrogen position in the ring. When R³ may be a hydroxyl group, the structure may be an azetidinium salt. Such salts are readily available from the reaction between either a primary amine or a secondary amine with epichlorohydrin following the two-step reaction as shown in equations 1 and 2.

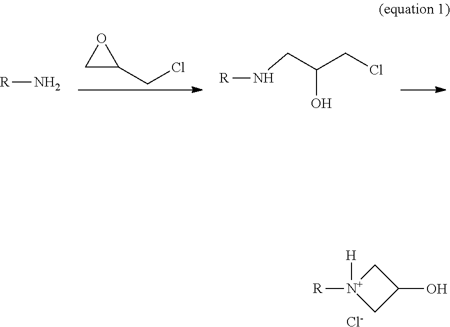

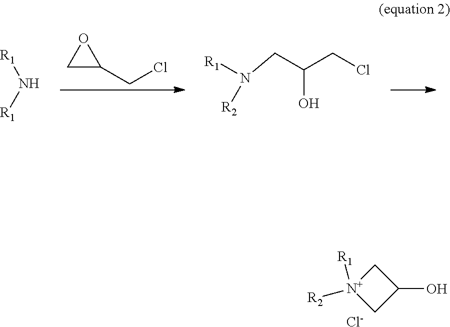

The nitrogen has a positive charge with halide such as chlorine as a counter-ion and the ring structure makes it reactive under even mild conditions with multiple functional groups such as carboxylates, amines, phenols, phosphorus nucleophiles as illustrated in equations 3 to 6:

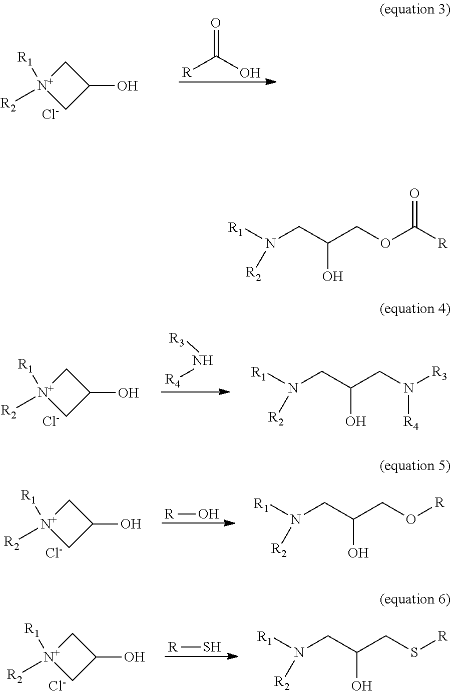

In other examples, the cross-linking agent may be a diallylazetidium salt (Formula 3), a bis(2-methoxyethyl)azetidinium salt (Formula 4), a nonylpropylazetidinium salt (Formula 5) a undecylmethylazetidinium salt (Formula 6) or a nonylpropargylazetidinium salt (Formula 7) and may be used singly or in combinations.

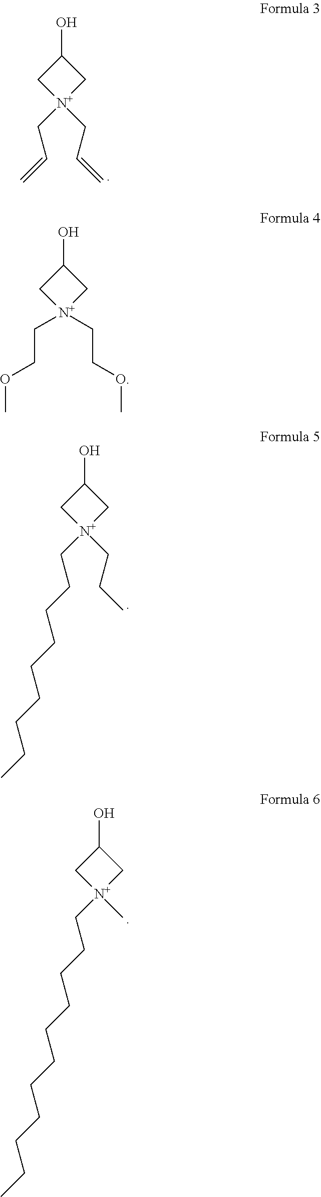

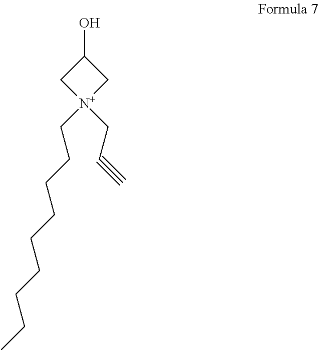 [SMILES: C#CC[N+]1(CCCCCCCCC)CC(O)C1]

The following are additional examples of azetidinium salt-based cross-linkers that can be prepared from the reaction of Jeffamine polyetheramines (Huntsman Corporation) with epichlorohydrin (equations 7-13):

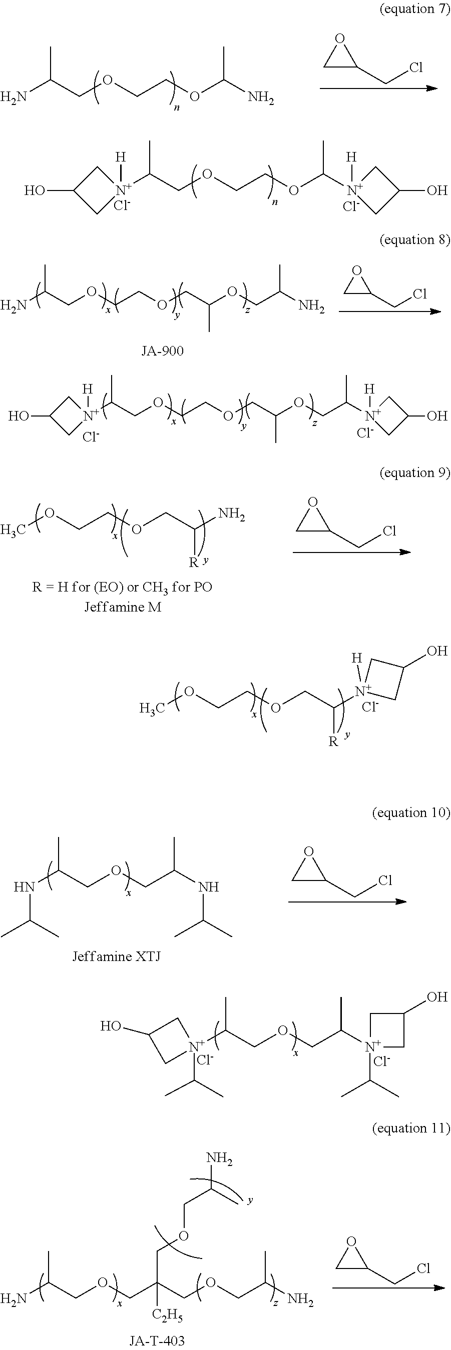

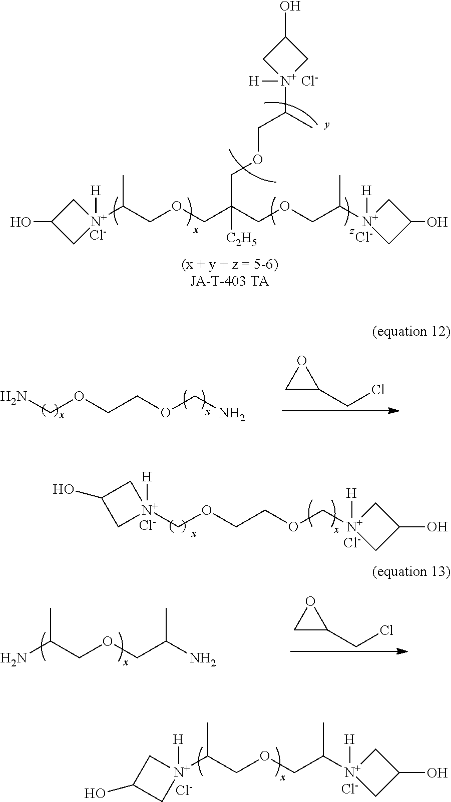

In other examples the cross-linking agent may be a polymeric heterocyclic salt having a polymeric backbone with appendant salt moieties, such as quaternary ammonium salts. In one example, the polymeric heterocyclic salt consists of four membered heterocyclic rings with a quaternary ammonium as is shown by Formula 10

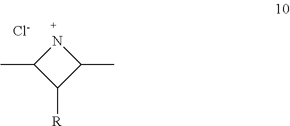

wherein R at the 3′-position may be hydroxyl, carboxy, acetoxy, alkoxy, amino or alkyl and the 1,1′-nitrogen position may be connected to a polymeric backbone having a long chain, such as a polyamide chain or polyalkylenepolyamine chain.

In one example, the polymeric oligomer to make polymeric heterocyclic salt (polyamide amine based azetidinium salt) may be prepared from polyamidoamine in following process:

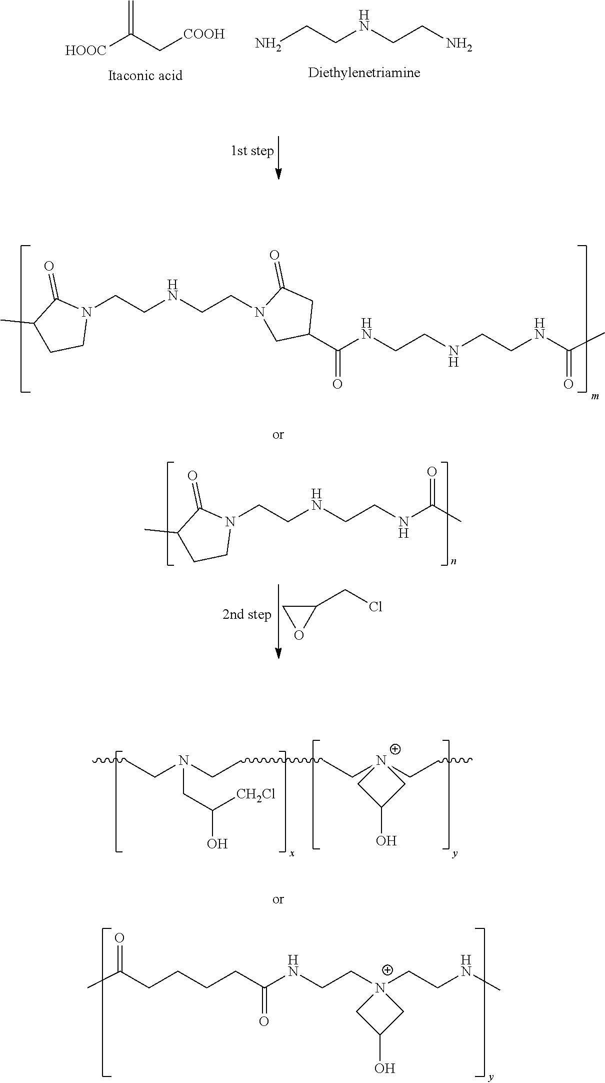

The backbone polymeric structure includes, but is not limited to, polyethylene imine, polyamidoamine, the polyamidoaminoester, or polyester backbones with pendant secondary amine groups.

It may be understood that the polymer may be both cationic (due to the quaternary ammonium group) and reactive due to the Bayer strain (angle strain) in the four-membered ring. The presence of these cationic functional polymers helps to bind anionically-dispersed pigmented ink colorant, where reactive functional groups can react with nucleophilic groups of the printing media surface and improve the adhesion via chemical bonding. Crosslinking may also improve hydrophobicity and/or durability of the coating.

Example polymeric heterocyclic salts are commercially available, for example, under the trade names Beetle® PT746 (from BIP (Oldbury) Ltd) and the Polycup® series (from Solenis, Inc), such as Polycup® 8210, Polycup® 9200, Polycup® 7535, Polycup® 7360A, Polycup® 2000, Polycup® 172 and Polycup® 9700.

### Ink Crashing Agent

The composition may, in some examples, further include an ink crashing agent which may further improve the print quality, by facilitating precipitation, or desolubilisation, of components of the ink used to overprint the treated or coated fabric. A crashing agent may be especially advantageous when the ink pigment or colorant shows strong dispersion in the liquid vehicle of the ink.

In certain examples, the composition comprises from about 0.02 wt. % to about 2.0 wt. % of the at least one ink crashing agent.

The ink crashing agent may be a polymeric, acidic or ionic composition or combinations thereof. The agent may be selected to crash or react with at least one pigment or colorant component of the ink with which the compositions of the present disclosure is intended to be used.

In one example, the ink crashing agent can be a water soluble metallic salt, either organic salt or an inorganic salt.

In some examples, the inorganic salts may be water-soluble and multi-valent charged salts. Multi-valent charged salts include cations, such as Group I metals, Group II metals, Group III metals, or transition metals, such as sodium, calcium, copper, nickel, magnesium, zinc, barium, iron, aluminium and chromium ions. The associated complex ion can be chloride, iodide, bromide, nitrate, sulfate, sulfite, phosphate, chlorate, acetate ions.

In other example, the ink crashing agent may be an organic salt and may be a water-soluble organic salt, such as a water-soluble organic acid salt. By the term ‘organic salt’, we refer to an associated complex ion that has an organic species and cations which may or may not the same as inorganic salt like metallic cations discussed above. Organic metallic salts are ionic compounds composed of cations and anions and having a formula such as (CₙH₂ₙ₊₁COO-M⁺)*(H₂O)m where M⁺ may be a cation species including Group I metals, Group II metals, Group III metals and transition metals such as, for example, sodium, potassium, calcium, copper, nickel, zinc, magnesium, barium, iron, aluminium and chromium ions. Anionic species can include any negatively charged carbon species with a value of n from 1 to 35. The hydrates (H₂O) are water molecules attached to salt molecules with a value of m from 0 to 20. Examples of water soluble organic acid salts include metallic acetate, metallic propionate, metallic formate, metallic oxalate, and the like. The organic salt may include a water dispersible organic acid salt. Examples of water dispersible organic acid salts include a metallic citrate, metallic oleate, metallic oxalate, and the like.

In some examples, the ink crashing agent may be a Group 2 acetate, propionate, formate or oxalate. In one example, the ink crashing agent is a Group 2 metal propionate, such as calcium propionate.

In some examples, the ink crashing agent can be an ionene compound. An ionene compound is a polymeric compound having ionic groups as part of the main chain, where ionic groups can exist on the backbone unit, or exist as the appendant groups to an element of the backbone unit, i.e. the ionic groups are part of the repeat unit of the polymer. In some example, the ionene compound may be a cationic charged polymer. The cationic ionene polymer may have a weight average molecular weight of 100 Mw to 8000 Mw.

Examples of such cationic charged polymers include: poly-diallyl-dimethyl-ammonium chloride, poly-diallyl-amine, polyethylene imine, poly2-vinylpyridine, poly 4-vinylpyridine poly2-(tert-butylamino)ethyl methacrylate, poly 2-aminoethyl methacrylate hydrochloride, poly 4′-diamino-3,3′-dinitrodiphenyl ether, poly N-(3-aminopropyl)methacrylamide hydrochloride, poly 4,3,3′-diaminodiphenyl sulfone, poly 2-(iso-propylamino)ethylstyrene, poly2-(N,N-diethylamino)ethyl methacrylate, poly 2-(diethylamino)ethylstyrene, and 2-(N,N-dimethylamino)ethyl acrylate.

The ionene compound may be a naturally occurring polymer such as cationic gelatin, cationic dextran, cationic chitosan, cationic cellulose or cationic cyclodextrin. The ionene polymer may alternatively be a synthetically modified naturally occurring polymer such as a modified chitosan, e.g., carboxymethyl chitosan or N,N,N-trimethyl chitosan chloride.

In some examples, the ionene compound may be a polymer having ionic groups as part of the main chain, where ionic groups exist on the backbone unit such as, for example, an alkoxylated quaternary polyamine having the Formula 8

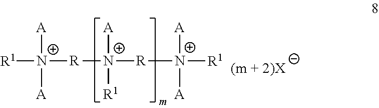

wherein R, R¹ and A can be the same or different and may be such as linear or branched C₂-C₁₂ alkylene, C₃-C₁₂ hydroxy-alkylene, C₄-C₁₂ dihydroxy-alkylene or dialkyl-arylene; X may be any suitable counter-ion, such as halogen or other similarly charged anions; and m has a numerical value to provide a polymer having a weight average molecular weight ranging from 100 Mw to 8000 Mw. In some examples, m may be an integer ranging from 5 to 3000. The nitrogen can be quaternized in some examples.

In some other examples, the ionene compound may be a polymer having ionic groups as part of the main polymer chain, but exist as the appending group to an element of the backbone unit. The ionic groups are not on the backbone but are part of the repeating unit of the polymer, such as quaternized poly(4-vinyl pyridine) of Formula 9 below:

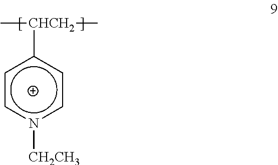

In this example, the above polymer units can repeat to provide a polymer with a weight average molecular weight ranging from 100 Mw to 8000 Mw.

In some examples, the ionene polymer may be a cationic gelatin, cationic dextran, cationic chitosan, cationic cellulose, cationic cyclodextrin, carboxymethyl chitosan, N,N,N-trimethyl chitosan chloride, alkoxylated quaternary polyamines, polyamines, polyamine salts, polyacrylate diamines, quaternary ammonium salts, polyoxyethylenated amines, quaternized polyoxyethylenated amines, poly-dicyandiamide, poly-diallyl-dimethyl ammonium chloride polymeric salt, quaternized dimethylaminoethyl(meth)acrylate polymers, polyethyleneimines, branched polyethyleneimines, quaternized poly-ethylenimine, polyureas, poly[bis(2-chloroethyl)ether-alt-1,3bis[3-(dimethylamino)propyl]urea], quaternized poly[bis(2-chloroethyl)ether-alt-1,3-bis[3-(dimethylamino)propyl], vinyl polymers or salts thereof, quaternized vinyl-imidazole polymers, modified cationic vinyl alcohol polymers, alkyl-guanidine polymers, or a combination thereof. The ionene compound can be selected from the group consisting of polyamines and/or their salts, poly-acrylate diamines, quaternary ammonium salts, poly-oxyethylenated amines, quaternized poly-oxyethylenated amines, poly-dicyandiamide, poly-diallyl-dimethyl ammonium chloride polymeric salt and quaternized dimethyl-aminoethyl(meth)acrylate polymers.

In some examples, the ionene compound may include polyimine compounds and/or their salts, such as linear polyethyleneimines, branched polyethyleneimines or quaternized poly-ethylene-imine.

In some examples, the ionene compound may be a substitute of urea polymer such as poly[bis(2-chloroethyl)ether-alt-1,3-bis[3-(dimethylamino)propyl]urea] or quaternized poly[bis(2 chloro-ethyl)ether-alt-1,3-bis[3-(dimethylamino)propyl]. In yet some other examples, the ionene compound may be a vinyl polymer and/or their salts such as quaternized vinyl-imidazole polymers, modified cationic vinyl-alcohol polymers, alkyl-guanidine polymers, and/or their combinations. The ionene compound can be a homopolymer of diallyl-dimethyl-ammonium chloride (poly-DADMA).

Commercially available ionene polymers include, for example, those sold under the trade marks BTMS-50, Incroquat®CR or Induquat®ECR from Indulor Chemie GmbH (Germany); Floquat® series from SFN Inc.; QUAB® series from SKW QUAB Chemicals Inc.; Tramfloc® series from Tramfloc Inc.; Zetag® series from BASF and ZHENGLI® from ZLEOR Chemicals Ltd.

### Other Additives

Depending on formulation preferences for the application and manufacturing, other additives, such as surfactants, thickening agents, optical dyes, defoamers and pH-control agents may be used in the compositions of the present disclosure.

In certain examples, the composition further comprises at least one surfactant. In some examples, the at least one surfactant may be present in an amount of from about 0.005 to about 0.05 wt %.

Any suitable surfactant may be present. Suitable surfactants may include non-ionic, cationic, and/or anionic surfactants. Examples include a silicone-free alkoxylated alcohol surfactant such as, for example, TEGO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), SURFYNOL® CT 211 (non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL™ TMN-3 and TERGITOL™ TMN-6 (both of which are branched secondary alcohol ethoxylate, non-ionic surfactants), and TERGITOL™ 15-S-3, TERGITOL™ 15-S-5, and TERGITOL™ 15-S-7 (each of which is a secondary alcohol ethoxylate, non-ionic surfactant) (all of the TERGITOL™ surfactants are available from The Dow Chemical Co.). Fluorosurfactants may also be employed.

In some examples, the surfactant may be an alcohol alkoxylate surfactant available under the trademark, Dynwet® 800.

In certain examples, the composition further comprises a pH adjustment composition. In some examples, the pH adjustment composition may be selected from acetic acid and sodium hydroxide.

### Fabric Substrate

The compositions of the present disclosure may be suitable for use with fabric substrates made of any kind of natural, synthetic or composition (blended) fabrics. In one example, the fabric substrate may be a cotton fabric, which may include, but is not limited to, regular plant cotton, organic cotton, pima cotton, supima cotton and slub cotton. In other examples, it can be made of other fabric substrates such as linen (from flax) which may have a textured weave structure, Lycra or Spandex (registered trade marks). In other examples, the fabric may be a synthetic fabric such as polyester, or man-made fibres produced from natural trees, cotton, and plants, such as rayon. The fabric may comprise a mixture of fibres, such as a mixture of both natural fibres and synthetic fibres, such as a polyester and cotton 50%/50% blended fabric, or tri-blends made up of three different types of material, such as polyester, cotton and rayon.

In some examples, the fabric substrate may be selected from the a single yarn material, such as cotton, woven to have a range of different structures due to the weaving method, for example as plain weave cotton, end-on-end weave, voile weave, twill weave, Oxford weave and so on.

In some examples, the fabric substrate may be made by a knitting method using the yarns listed above, or by a special knitting processes to produce a fabric substrate such as scuba double-knit fabric which may usually be made of polyester mixed with either Lycra or Spandex (registered trade marks).

### Method of Application of Fabric Treatment Compositions to the Fabric

The fabric treatment compositions of the present disclosure can be applied to the fabric substrate as part of the printing process, in which case the application apparatus may be incorporated into the printer apparatus, or away from the printer process, such as being accomplished in a fabric manufacture site such as in a finishing procedure in a dye house, generating a pre-treated substrate before printing operation.

In some examples, once the fabric treatment composition is applied to the fabric substrate, the fabric substrate may be pressed prior to printing. In some examples, the pressure, that may be applied, may be about 69-1030 kPa (about 10 to about 150 PSI) optionally between about 200 and 480 kPa (about 30 to about 70 PSI). In some examples, pressing may cause the fibres of the fabric to become better aligned along the plane of the fabric.

In one example, the processing can be carried out using padding procedures. The fabric substrate can be soaked in a bath and the excess can be rolled out. More specifically, impregnated fabric substrates (prepared by bath, spraying, dipping, etc.) can be passed through padding nip rolls under pressure. The impregnated fabric, after nip rolling, can then be dried with application of heat for an appropriate period of time, which may be controlled by machine speed at an appropriate peak fabric web temperature. In some examples, pressure can be applied to the fabric substrate after impregnating the base fabric substrate with the fabric treatment composition. In some other examples, the surface treatment may be accomplished in a pressure padding operation. During such operation, the base fabric substrate may first be dipped into a pan containing the fabric treatment or coating composition and may be then passed between padding rolls. The padding rolls (a pair of two soft rubber rolls or a metal chromic metal hard roll and a tough-rubber synthetic soft roll, for example), apply a pressure to composition-wetted fabric material so that composition amount can be accurately controlled. In some examples, the pressure that may be applied may be about 69-1030 kPa (about 10 to about 150 PSI) optionally between about 200 and 480 kPa (about 30 to about 70 PSI).

The composition-treated fabric can be dried using box hot air dryer. The dryer can be a single unit or a series assembly of several units (typically 3 to 7 units) to generate a temperature profile with initial higher temperature (to remove excess water) and mild temperature in the final units (to ensure complete drying, with a final moisture level of about 3-5%, for example). The peak dryer temperature can be programmed into a profile with a higher temperature at the beginning of the drying when moisture may be higher and reduced to a lower temperature as the fabric web becomes drier. The dryer temperature may be controlled to a temperature of about 70° C. to about 120° C. In some examples, the operation speed of the padding/drying line may be about 50 metres per minute (about 50 yards per minute).

In alternative arrangements, the treatment may be accomplished by the device integrated to the printer. In this case, the composition may be applied on the fabric substrate by a method such as those described below, and then pass to the printing head. In other words, printing may be carried out in a “wet (ink)-on-wet(media)” process compared with the “wet(ink)-on-dry(media)” system described above.

Where a cross-linking agent is present, the treated substrate may be treated to effect cross-linking to cure the coating. For example, the treated substrate may be heated at elevated temperatures, for example, at temperatures of above 60° C. to effect crosslinking. Examples of suitable temperatures include temperatures of, for example, at least 70° C. or at least 80° C. Suitable upper limits include temperatures of up to 220° C., for example, up to 200° C., up to 180° C. or up to 160° C. In some examples, curing temperatures of 60 to 220° C., for example, 70 to 200° C. or 80 to 180° C. or 80 to 160° C. may be employed.

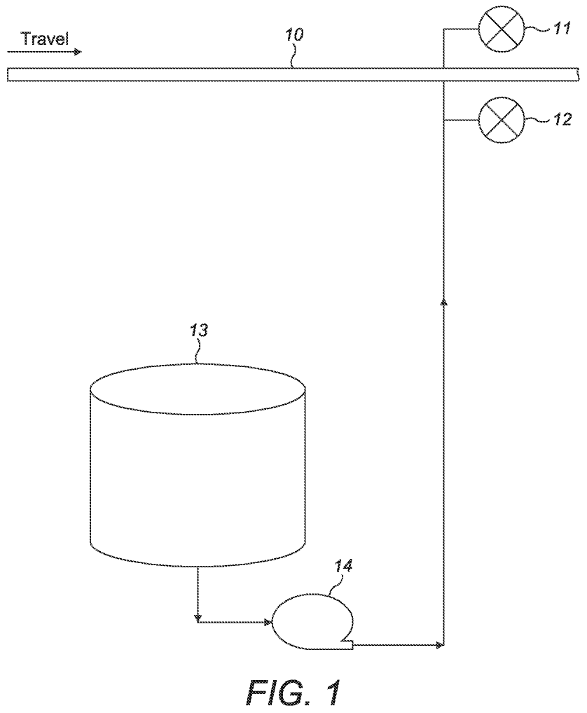

In one example, illustrated in FIG. 1, a fabric substrate 10 may be passed under an adjustable spray nozzle system comprising, in the system illustrated, a pair of opposed spray nozzles 11, 12 supplied with fabric treatment composition from a storage tank 13 by means of a pump 14. The adjustable spray nozzle system may be advantageously configurable to vary the rate at which the composition may be sprayed onto the fabric substrate. By adjusting factors such as the rate at which the fabric substrate 10 may be passed under the nozzle, the rate at which the composition solution may be sprayed on the base paper, the distance of the fabric substrate from the nozzle, the spraying profile of the nozzle, and the concentration of the fabric treatment solution, a layer of fabric treatment composition with desired attributes may be deposited on the fabric substrate. The system may be operated to apply the composition from both spray nozzles 11, 12 simultaneously to treat both faces of fabric substrate 10, or operated with just a single nozzle, to apply composition to a single face.

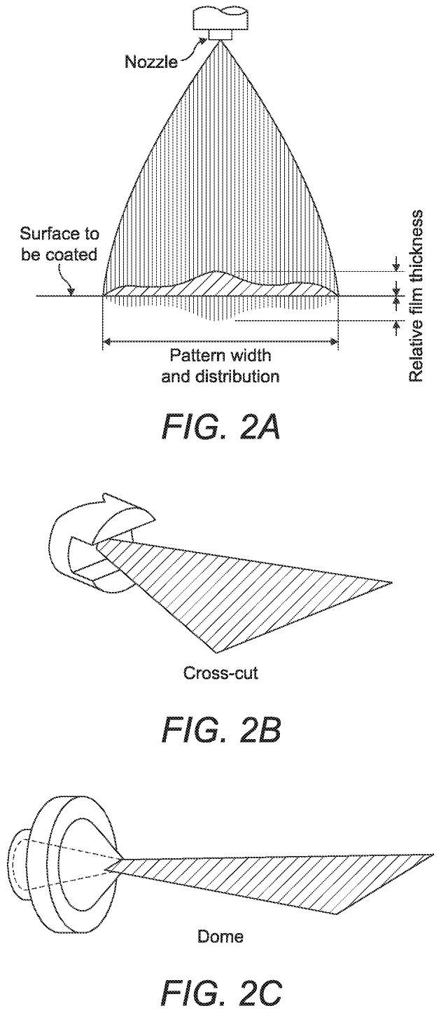

FIG. 2A illustrates an exemplary nozzle spray pattern, showing spray width, distribution and thickness across a fabric substrate. FIGS. 2B and 2C show suitable nozzle constructions, in the form of a cross-cut nozzle and dome nozzle respectively.

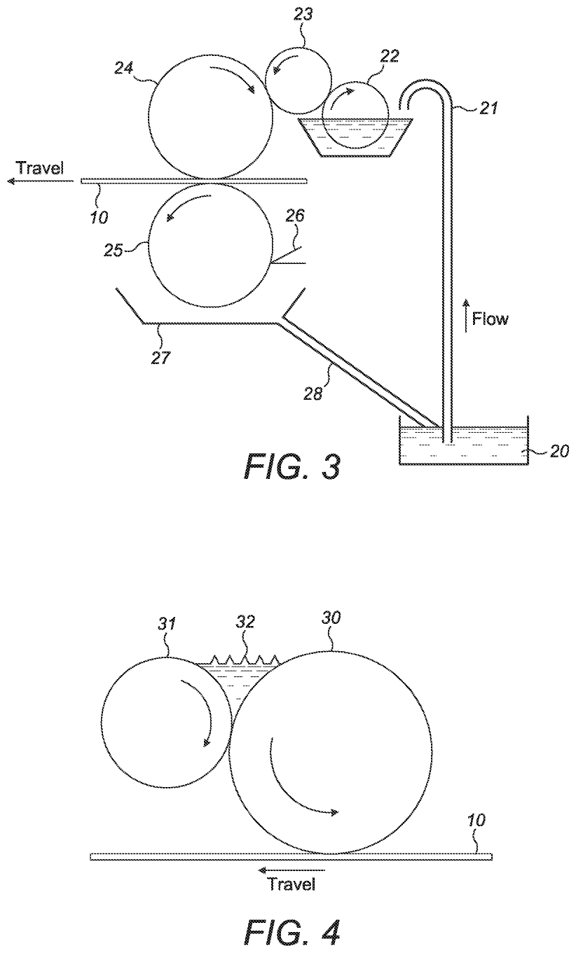

In other examples, the compositions of the present disclosure may be applied using roller techniques, of which several are illustrated in FIGS. 3 to 7.

FIG. 3 shows an arrangement comprising a feed (pick-up) roller and a transfer roller. The treatment composition may be pumped from a storage container 20, through a transfer pipe 21 to a feed roller 22. The composition may be transferred by a transfer roller 23 to an application roller 24. A pressure roller 25 may be arranged in an opposed relationship with application roller 24, with the pressure roller mounted below the application roller, and the fabric substrate 10 passes therebetween in the direction shown by the arrow to cause the composition to be applied to the substrate at a predetermined pressure. A scraper bar 26 may be associated with the pressure roller 25 to remove excess composition, which flows to a receiver trough 27 from which the excess composition flows, through return pipe 28 to container 20.

An alternative arrangement is illustrated in FIG. 4 in which the composition may be applied to the substrate 10 by a coating roller 30. A doctor roller 31 may be disposed adjacent coating roller 30 and the composition of the present disclosure supplied to the nip between the rollers 30,31.

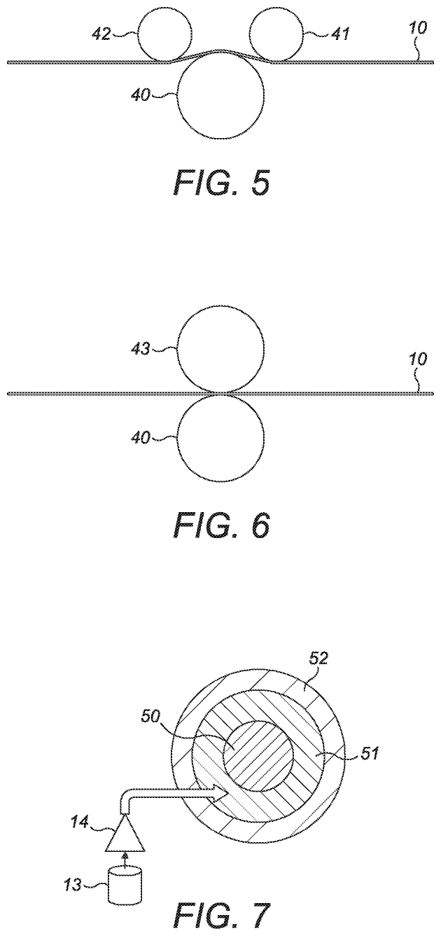

FIG. 5 shows a modification in which a spaced pair of guide rolls 41,42 may be disposed opposite a coating roller 40 with the substrate 10 to be coated passing between the coating roller 40 and the pair of guide rolls 41,42.

FIG. 6 shows a further modification in which the substrate 10 passes between a coating roller 40 mounted below a pressure roller 43.

FIG. 7 schematically shows an exemplary construction for a coating roller as may be used, for example, in the arrangements of FIGS. 5 and 6. The coating roller has a resilient core 50, suitably a steel core. Core 50 has an over-sleeve 51, typically formed of an open-celled foam material, which acts as a composition storage buffer. The roller has an outer layer 52, suitably formed of a porous rubber material, through which composition, supplied to storage buffer sleeve 51 by a pump 14 from a storage container 13, may be metered to the fabric substrate.

In the examples illustrated, the roller assemblies may be into a printer or may be provided adjacent or remote the printer.

### Ink Compositions

The ink compositions, including white ink compositions or CMYK compositions employed in examples of the present disclosure, may comprise a pigment or colorant dispersed in a carrier liquid. The compositions may also include a polymer binder, surfactant and/or an anti-kogation agent. The compositions may be printed by inkjet printing and can, therefore, be referred to as inkjet ink compositions.

The inkjet ink compositions may comprise a polymer binder, such as a polyurethane dispersion, polyacrylic latex polymer or polyurethane-latex hybrid polymer, together with a pigment and an aqueous carrier. The polymer (solids) may be dispersed in an inkjet ink composition may be present in the inkjet ink composition an amount of 0.1 to 30 or 20 weight % or 0.1 to 10 weight %, for example, 0.5 to 7 weight %, or 0.6 to 5 weight % of the total weight of the inkjet ink composition.

The aqueous carrier may be water, present in the inkjet ink composition in an amount of at least 30 weight %, for example, at least 40 or 50 weight %. In some examples, water may be present in the inkjet ink composition in an amount of at least 60 weight %. Water may be present in an amount of at most 99 weight %, for example, at most 95 weight %. In some examples, water may be present in the inkjet ink composition in an amount of 30 to 99 weight %, for instance, 40 to 98 weight % or 50 to 95 weight %. In other examples, water may be present in an amount of 60 to 93 weight %, for instance, 70 to 90 weight %.

The inkjet ink composition may also include a surfactant. Any suitable surfactant may be present. Suitable surfactants may include non-ionic, cationic, and/or anionic surfactants. Examples include a silicone-free alkoxylated alcohol surfactant such as, for example, TECO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), SURFYNOL® CT 211 (non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL™ TMN-3 and TERGITOL™ TMN-6 (both of which are branched secondary alcohol ethoxylate, non-ionic surfactants), and TERGITOL™ 15-S-3, TERGITOL™ 15-S-5, and TERGITOL™ 15-S-7 (each of which is a secondary alcohol ethoxylate, non-ionic surfactant) (all of the TERGITOL™ surfactants are available from The Dow Chemical Co.). Fluorosurfactants may also be employed.

The inkjet ink composition may also include a co-solvent, in addition to water. Classes of co-solvents that may be used can include organic co-solvents, including alcohols (e.g., aliphatic alcohols, aromatic alcohols, polyhydric alcohols (e.g., diols), polyhydric alcohol derivatives, long chain alcohols, etc.), glycol ethers, polyglycol ethers, a nitrogen-containing solvent (e.g., pyrrolidinones, caprolactams, formamides, acetamides, etc.), and sulfur-containing solvents. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. Further examples of suitable co-solvents include propylene carbonate and ethylene carbonate.

The aqueous ink jet compositions may further include at least one humectant. Humectants for use in ink jet ink compositions are known in the art and are suitable for use herein. Examples include, but are not limited to, alcohols, for example, glycols such as 2,2′-thiodiethanol, glycerol, 1,3-propanediol, 1,5-pentanediol, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol. Advantageously, the humectants may be selected from the group consisting of 2,2′-thiodiethanol, glycerol, 1,3-propanediol, 1,5-pentanediol, polyethylene glycol, ethylene glycol, diethylene glycol, propylene glycol, tetraethylene glycol, 2-pyrrolidone, n-propanol and mixtures thereof. In one example, the humectant comprises a mixture of alcohols. In a further example, the humectant comprises a mixture of 2,2′-thiodiethanol and a glycol such as a polyalkylene glycol.

A single co-solvent may be used, or several co-solvents may be used in combination. When included, the co-solvent(s) is/are present in total in an amount ranging from 0 wt % to 60 wt %, depending on the jetting architecture, though amounts outside of this range can also be used. As other example, the co-solvent(s) may range from about 1 wt % to about 30 wt % or about 20 wt % of the total wt % of the inkjet ink composition.

The inkjet ink composition may also include various other additives to enhance the properties of the ink composition for specific applications. Examples of these additives include those added to inhibit the growth of microorganisms, viscosity modifiers, materials for pH adjustment, sequestering agents, anti-kogation agents, preservatives, and the like. Such additives may be present in an amount of 0 to 5 wt % of the inkjet ink composition.

The inkjet ink composition also includes one or more pigment components to provide an ink composition having the desired visual characteristics of colour and tone. In some examples, the pigment can be present in an amount from about 0.5 wt % to about 15 wt % based on a total wt % of the inkjet ink composition. In one example, the pigment can be present in an amount from about 1 wt % to about 10 wt %. In another example, the pigment can be present in an amount from about 5 wt % to about 10 wt %.

As used herein, the term “pigment” generally includes organic or inorganic pigment colorants, magnetic particles, aluminas, silicas, TiO₂ particles and/or other ceramics, organo-metallics or other opaque particles, whether or not such particulates impart colour. Thus, although the present description primarily illustrates the use of pigment colorants, the term “pigment” can be used more generally to describe pigment colorants, as well as other pigments such as organometallics, ferrites, ceramics, etc.

Where the ink composition is a white ink, the white pigment may be or include titanium dioxide. The pigment (e.g. titanium dioxide) may be present in an amount of 0.1 to 20 weight %, for example, 5 to 15 weight % or about 6 to 12 weight %, for instance, 10 weight %.

Where the ink composition is a CMYK ink, the pigment of colorant may be present in an amount of 0.1 to 20 weight %, for example, 0.5 to 10 weight %, or 1 to 6 weight % or 2 to 5 weight %. As described above, CMYK inks may be applied e.g. by inkjet printing over a white ink layer formed from a white ink composition.

After the substrate is printed with the ink composition, the printed substrate may be treated at elevated temperatures, for example, at temperatures of above 60° C. Heating may facilitate crosslinking or curing, or may help to promote adhesion of the image onto the substrate. Examples of suitable temperatures include temperatures of, for example, at least 70° C. or at least 80° C. Suitable upper limits include temperatures of up to 220° C., for example, up to 200° C., up to 180° C. or up to 160° C. In some examples, curing temperatures of 60 to 220° C., for example, 70 to 200° C. or 80 to 180° C. or 80 to 160° C. may be employed.

### Crosslinking Composition

As mentioned above, in some examples, a crosslinking composition may be applied before or after application of the ink composition (e.g. white ink composition) onto the coating. The crosslinking composition may be applied by inkjet printing. The crosslinking composition may be applied between e.g. consecutive white ink layers, where multiple white ink layers are applied over the coating.

The crosslinking composition may comprise a crosslinking agent as described above. The crosslinking agent may be present in an amount of 0.1 to 20 weight %, for example, 0.5 to 10 weight % or 1 to 8 weight % of a crosslinking agent. This crosslinking agent may be dispersed in an aqueous carrier.

The aqueous carrier may be water, present in the crosslinking composition in an amount of at least 30 weight %, for example, at least 40 or 50 weight %. In some examples, water may be present in the crosslinking composition in an amount of at least 60 weight %. Water may be present in an amount of at most 99 weight %, for example, at most 95 weight %. In some examples, water may be present in the inkjet ink composition in an amount of 30 to 99 weight %, for instance, 40 to 98 weight % or 50 to 95 weight %. In other examples, water may be present in an amount of 60 to 93 weight %, for instance, 70 to 90 weight %.

The crosslinking composition may also include a surfactant. Any suitable surfactant may be present. Suitable surfactants may include non-ionic, cationic, and/or anionic surfactants. Examples include a silicone-free alkoxylated alcohol surfactant such as, for example, TECO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), SURFYNOL® CT 211 (non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL™ TMN-3 and TERGITOL™ TMN-6 (both of which are branched secondary alcohol ethoxylate, non-ionic surfactants), and TERGITOL™ 15-S-3, TERGITOL™ 15-S-5, and TERGITOL™ 15-S-7 (each of which is a secondary alcohol ethoxylate, non-ionic surfactant) (all of the TERGITOL™ surfactants are available from The Dow Chemical Co.). Fluorosurfactants may also be employed.

The crosslinking composition may also include a co-solvent, in addition to water. Classes of co-solvents that may be used can include organic co-solvents, including alcohols (e.g., aliphatic alcohols, aromatic alcohols, polyhydric alcohols (e.g., diols), polyhydric alcohol derivatives, long chain alcohols, etc.), glycol ethers, polyglycol ethers, a nitrogen-containing solvent (e.g., pyrrolidinones, caprolactams, formamides, acetamides, etc.), and sulfur-containing solvents. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. Further examples of suitable co-solvents include propylene carbonate and ethylene carbonate.

The crosslinking compositions may further include at least one humectant. Humectants for use in such compositions are known in the art and are suitable for use herein. Examples include, but are not limited to, alcohols, for example, glycols such as 2,2′-thiodiethanol, glycerol, 1,3-propanediol, 1,5-pentanediol, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol. Advantageously, the humectants may be selected from the group consisting of 2,2′-thiodiethanol, glycerol, 1,3-propanediol, 1,5-pentanediol, polyethylene glycol, ethylene glycol, diethylene glycol, propylene glycol, tetraethylene glycol, 2-pyrrolidone, n-propanol and mixtures thereof. In one example, the humectant comprises a mixture of alcohols. In a further example, the humectant comprises a mixture of 2,2′-thiodiethanol and a glycol such as a polyalkylene glycol.

A single co-solvent may be used, or several co-solvents may be used in combination. When included, the co-solvent(s) is/are present in total in an amount ranging from 0 wt % to 60 wt %, depending on the jetting architecture, though amounts outside of this range can also be used. As other example, the co-solvent(s) may range from about 1 wt % to about 30 wt % or about 20 wt % of the total wt % of the composition.

The composition may also include various other additives to enhance the properties of the ink composition for specific applications. Examples of these additives include those added to inhibit the growth of microorganisms, viscosity modifiers, materials for pH adjustment, sequestering agents, anti-kogation agents, preservatives, and the like. Such additives may be present in an amount of 0 to 5 wt % of the composition.

Where a crosslinking composition is applied, the treated substrate may be treated at elevated temperatures, for example, at temperatures of above 60° C. Such elevated temperatures may be required to effect crosslinking to cure the ink layer. Examples of suitable temperatures include temperatures of, for example, at least 70° C. or at least 80° C. Suitable upper limits include temperatures of up to 220° C., for example, up to 200° C., up to 180° C. or up to 160° C. In some examples, curing temperatures of 60 to 220° C., for example, 70 to 200° C. or 80 to 180° C. or 80 to 160° C. may be employed.

As mentioned above, the crosslinking composition may be used to cause a cross-linking reaction that can improve adhesion of any underlying or overlying ink layer. Crosslinking may also improve hydrophobicity and/or durability of the layer(s).

### Definitions

As used in the present disclosure, the term “about” is used to provide flexibility to an endpoint of a numerical range. The degree of flexibility of this term can be dictated by the particular variable and is determined based on the associated description herein.

Amounts and other numerical data may be expressed or presented herein in a range format. It is to be understood that such a range format is used merely for convenience and brevity and thus should be interpreted flexibly to include not just the numerical values explicitly recited as the limits of the range, but also to include individual numerical values or sub-ranges encompassed within that range as if each numerical value and sub-range is explicitly recited.

As used in the present disclosure, the term “comprises” has an open meaning, which allows other, unspecified features to be present. This term embraces, but is not limited to, the semi-closed term “consisting essentially of” and the closed term “consisting of”.

It is noted that, as used in this specification and the appended claims, the singular forms “a”, “an” and “the” include plural referents unless the context clearly dictates otherwise.

L* is the lightness element of the CIELAB Color Space defined by the International Commission on Illumination (CIE). L* defines a value for the whiteness, from black (0) to white (100).

In this application, the terms “fabric” and “textile” are used interchangeably except where indicated or where the context requires otherwise.

Compositional amounts are given as percentages or parts by weight (wt %) except where indicated or where the context indicates otherwise.

### EXAMPLES

Inks used for the printing tests on fabric samples were formulated based on the following recipe: 6% of Impranil® DLN-SD, 6% of glycerol, 0.5% of Crodafos® N-3 Acid, 1% of LEG-1, 0.22% of Aticide® B20, 0.3% of Surfynol 440, 10% TiO₂ dispersion for white ink, or 3% of cyan pigment dispersion for cyan ink or 2.5% carbon black dispersion for black ink and balance of water. The prints were printed on Innovator durability plot (3 dpp ink), A3410 pen on Gildan® 780 black T-shirt fabric and Gildan® 780 white T-shirt fabric without using any pre-printing processing such as using water to pre-wet the substrate. Comparative examples were carried out similarly, without any prior treatment with compositions of the present disclosure.

Fabric treatment formulations for pre-treatment of a black substrate, prior to printing with white pigmented ink, are listed in Table 1.

TABLE 1
Composition formulations

| | | | | % by wet weight | | |
|---|---|---|---|---|---|---|
| | Concentration | Chemical | Chemical | | Exp. | Exp. 3 |
| | (as supplied) | Supplier | Function | Exp. 1 | 2 | (Comparative) |
| PHOBOL ® CP-C | 15% | Huntsman | Hydrophobicity | 7.20 | 7.18 | Gildan 780 |
| | | Co. | agent | | | Black fabric, |
| Raycat ® 100 | 43% | Specialty | Fibre-bonding | 0.84 | 0.84 | No treatment |
| | | Polymers | agent | | | |
| | | Inc | | | | |
| Polycup ® 7360A | 38% | Solenis Inc | Cross-linking agent | 0.46 | 0.45 | |
| Calcium | 100% | Aldrich Inc | Ink crashing agent | 0.036 | 0 | |
| Propionate | | | | | | |
| Dynwet ® 800 | 100% | BYK Inc | Surfactant | 0.02 | 0.02 | |
| Acetic acid/ | | Aldrich Inc | pH adjustment | Adjust to | Adjust | |
| NaOH | | | | pH = 5-6 | to | |
| | | | | | pH = 5-6 | |
| Water | | | Solvent | 91.9 | 91.9 | |

The treated black substrate was printed with a white ink as described above and the prints were cured at 150° C. for 3 min. The durability of the printed images was tested after 5 washing cycles using a conventional washing machine (Whirlpool, model 589-01) on a 40° C., 50 min washing cycle with a detergent (Tide (registered trade mark) liquid detergent). The printed fabrics were air dried between washing cycles. The La*b* before and after the washes were measured with an X-Rite spectrophotometer and the results are given in Table 2 and Table 3. ΔE is calculated with the following equation:

$$Δ E = \sqrt{{( Δ {L}^{*} )}^{2} + {( Δ {a}^{*} )}^{2} + {( Δ {b}^{*} )}^{2}}$$

A smaller value for ΔE indicates a smaller change in optical colour density.

The test results for opacity (L*—higher values are better) and durability (ΔE—lower values are better) are listed in Table 2.

TABLE 2

| | Print | | | |
|---|---|---|---|---|
| Example ID | substrate | Print ink | L* | AE |
| Example 1 | Exp 1 | As described in | 89.7 | 1.2 |
| | | examples | | |
| Example 2 | Exp 2 | As described in | 89.1 | 0.8 |
| | | examples | | |
| Example 3 | Exp 3 | As described in | 75.2 | 6.2 |
| (Comparative)* | | examples | | |

*No pre-treatment used

As can be seen from the results set out in Table 2, examples of the present disclosure perform considerably better than the comparative untreated example on both image quality and image durability.

Further example fabric treatment compositions were prepared and tested with fibre-bonding agents having different glass transition temperatures. The comparison formulations are identical in their compositions to Exp 1 above except in their fibre-bonding agent and are set out in Table 3. The treatment results were test in terms of softness, shininess, stickiness and elasticity assessed by hand test (multiple users) and fibre loss or ‘dirt’ (black fibres visible on the white ink surface) after printing, as assessed by visual inspection. A score of 5 for softness indicates that the treated and fabrics are soft and have a similar feel to the hand as the untreated fabric. A shininess, with score of 5 indicates that the treated fabric has a low light reflection under different view angles. A score of 5 for stickness indicates that the fabric did not show any discernible resistance to a hand touching and moving on the surface. Elasticity refers in this application both to resistance to folding and strength. A score of 5 for fibre loss means that no or very few visible lost fibres appeared on the white ink background.

TABLE 3

| ID/Fibre-bonding agent | | | | | | | |
|---|---|---|---|---|---|---|---|
| | Fibre- | Tg of fibre- | | | | | |
| | bonding | bonding | Performance | | | | |
| Example | agent | agent | Softness | Stickness | Shininess | Elasticity | Fibre loss |
| Exp 1 | Raycat ® | −10 | 5 | 4-5 | 5 | 5 | 4-5 |
| | 100 | | | | | | |
| Exp 4 | Rovene ® | −38 | 5 | 2-3 | 5 | 5 | 5 |
| | 4848 | | | | | | |
| Exp 5 | Raycat ® | 26 | 2-3 | 5 | 3 | 3 | 3-4 |
| | 105 | | | | | | |
| Exp 6 | None | NA | 5 | 5 | 4-5 | 4-5 | 1-3 |
| (Untreated) | | | | | | | |

As can be seen, the examples of the present disclosure having a Tg of less than 5° C. show less fibre loss than the example having a Tg of greater than 5° C. or the untreated fabric. All examples of the present disclosure show less fibre loss than the untreated fabric. It can also be seen that softness, stickiness, shininess and elasticity vary with glass transition temperature. Certain of these parameters may be significant considerations for the consumer with certain types of products. For example, parameters affecting the touch or feel of a product, such as softness and elasticity may be important consumer considerations in clothing, but less important in fabrics for other products, whether other considerations may be more relevant to a consumer.

In summary, the present disclosure discloses a fabric treatment composition and methods to make and apply such a composition to a fabric substrate. The treated or coated fabrics may be used as printing substrates for digital pigmented ink printing. The fabric treatment composition comprises at least one fibre-bonding agent and at least one cross-linking agent. An ink crashing agent may also be included in the composition. The methods to use such fabric treatment compositions to make the printing media are wide ranging and include, for example, roller and spray application methods which may be performed in either the fabric production or dye house or in a device conveniently integrated inside a digital printer. It may be observed that the said fabric treatment composition can significantly improve the printing duality, especially in the case of white ink printing on black substrate. The value of L* value can be over 10 units higher after application of the fabric treatment composition of the present disclosure while no other pre-printing processing may be required.

Further advantages of the compositions of the present disclosure include avoiding the need for excessive volumes of water and/or aqueous solution before inkjet printing to reduce protruding fabric fibres. Consequently, printing speed can be increased and printer hardware simplified, with reduced printer cost and operation cost. The present disclosure provides increased flexibility to end customers. A pre-treated fabric substrate can be used directly without need any pre-printing treatment, or they can use a simple rolling processing on any fabric substrate.

1. A fabric treatment composition for preparing a fabric substrate for printing, wherein the fabric treatment composition comprises at least one fibre-bonding agent, at least one hydrophobicity agent and at least 50 weight % water.

2. The composition of claim 1 wherein the at least one fibre-bonding agent is present in an amount of from about 0.05 wt % to about 2 wt %; the at least one hydrophobicity agent is present in an amount of from about 0.1 wt % to about 10 wt %; and the water is present in an amount of from about 85 wt % to about 99.5 wt %.

3. The composition of claim 1 wherein the fibre-bonding agent has a glass transition temperature (Tg) of less than 5° C.

4. The composition of claim 1 wherein the fibre-bonding agent is selected from acrylic polymers, polyvinyl acetates, polyesters, polyvinylidene chlorides, styrene-butadiene copolymers, acrylonitrile-butadiene copolymers; and polyurethanes.

5. The composition of claim 1 wherein the fibre-bonding agent has an average molecular weight (Mw) of about 500 to about 200,000.

6. The composition of claim 1 wherein the at least one hydrophobicity agent is at least one agent selected from fluorocarbon compounds and silicone-based compounds.

7. The composition of claim 1 further comprising at least one of: i) at least one cross-linking agent; and ii) at least one ink-crashing agent.

8. The composition of claim 7 wherein the at least one cross-linking agent is a quaternary ammonium salt of a four membered heterocyclic ring.

9. The composition of claim 7 wherein the at least one ink crashing agent is at least one agent selected from water soluble metallic salts and ionene compounds.

10. A method for printing a fabric substrate, said method comprising
i) applying, to at least one area of a fabric substrate, a fabric treatment composition to form a coating, wherein the fabric treatment composition comprises at least one fibre-bonding agent, at least one hydrophobicity agent and at least 50 weight % water; and
ii) printing at least one ink composition over the coating.

11. The method of claim 10 wherein the at least one ink composition is a white ink composition comprising titanium dioxide, a polymer binder and a carrier liquid.

12. The method of claim 11, which further comprises printing at least one CMYK ink onto an ink layer formed from the white ink composition.

13. The method of claim 11, wherein the white ink composition comprises titanium dioxide; a polyurethane or acrylic binder; a phosphate ester and a carrier liquid.

14. The method of claim 10, which further comprises printing a crosslinking composition onto the ink layer formed by the printed ink composition.

15. printable fabric medium comprising:
i) a fabric substrate; and
ii) a coating formed on at least one side of at least an area of the substrate;
wherein the coating comprises a fabric treatment composition comprising at least one fibre-bonding agent and at least one hydrophobicity agent.
